(19) United States
(12) Patent Application Publication
(10) Pub. No.: US 2006/0116024 A1
(43) Pub. Date: Jun. 1, 2006

(54) MULTIPLE ANGLE TUBULAR CONTAINER

(75) Inventor: James Baechle, Hendersonville, TN (US)

Correspondence Address: CLAUSEN MILLER, P.C, SUITE 1600, 10S. LASALLE STREET, CHICAGO, IL, 60603, US

(73) Assignee: SONOCO DEVELOPMENT, INC., Hartsville, SC (US)

(21) Appl. No.: 10/904,782

(22) Filed: Nov. 29, 2004

(51) Int. Cl. H01R 13/40

(52) U.S. Cl. 439/596

(57) ABSTRACT

A tubular container that can be bent at multiple angles to hold and protect irregular (non-straight) items. The container comprises at least one rigid, hollow straight section and at least one hollow tubular connector piece. The connector piece is configured to fit partially within the straight sections and comprises at least one V-shaped notch at which the tubular container can bend.

### FIELD OF THE INVENTION

This patent relates to a container for holding and shipping non-straight products such as automobile body molding, vehicle brake lines or other bent tubing products.

### DESCRIPTION OF THE RELATED ART

Round tubular shipping containers (i.e. tubular containers having round cross-sections) are useful for protecting and shipping straight products such as window blinds, golf clubs and fishing poles. However, round shipping containers can roll off flat tables and conveyor belts and generally are limited to items that are straight. Even non-round or flat sided tubular shipping containers, if rigid, generally cannot be used to protect irregular (non-straight) items because they cannot bend.

The present invention overcomes these disadvantages by providing a rigid, flat-sided tubular shipping tube that can bend at various angles in order to accommodate irregular shaped (non-straight) items.

Further objects of the invention will appear from the description, accompanying drawings, and appended claims.

### SUMMARY OF THE INVENTION

The present invention is a tubular container that can be bent at multiple angles to hold and protect irregular (non-straight) items. The container comprises at least one rigid, hollow straight section and at least one hollow tubular elbow or connector piece. The connector is configured to fit partially within the straight sections and comprises at least one V-shaped notch at which the tubular container can bend.

Each straight section is formed from a folded blank and has a polygonal cross-section. For example, in a preferred embodiment, each straight section comprises four substantially rectangular panels folded into a tubular shape having a triangular cross-section.

Each connector is also formed from a folded blank and has a polygonal cross-section. The blank comprises cut out sections that, when the blank is folded, form the V-shaped notches. In a preferred embodiment, each connector comprises four substantially rectangular panels folded into a tubular shape having a triangular cross-section. Each connector is slightly smaller than the straight sections so that it can fit within the straight sections.

To assemble a tubular container, a connector is inserted inside either end of a center straight section up to the desired V-shaped notch. A second connector may be inserted into the opposing end of the straight section up to a V-shaped notch having the same or a different angle as the notch on the first connector. Additional straight sections may be slid over the connectors up to the V-shaped notches, leaving the notches exposed so that the container can bend at the notches. The assembled container can be bent or folded up to the predetermined angle(s) defined by the notches with the connectors acting as hinges.

Any number of straight sections may be connected using the connectors. End caps may be used to cover the exposed ends of the assembled container.

### THE DRAWINGS

FIG. 1 is a perspective view of a multiple angle tubular container according to the present invention.

FIG. 2 is a perspective view of a straight section used in the container of FIG. 1.

FIG. 2A is an elevational view of an end of the straight section of FIG. 2.

FIG. 3 is a top plan view of a blank used to make a connector used in the container of FIG. 1.

FIG. 4 is a perspective view of a connector used in the container of FIG. 1.

FIG. 5 is a top view of the connector of FIG. 4.

FIG. 6 is a side view of the connector of FIG. 4.

FIG. 7 is an elevational view of an end of the connector of FIG. 4.

FIG. 8 is a perspective view of the multiple angle tubular container of FIG. 1 shown in a straight position and in phantom lines in an angled position.

### DETAILED DESCRIPTION OF THE INVENTION

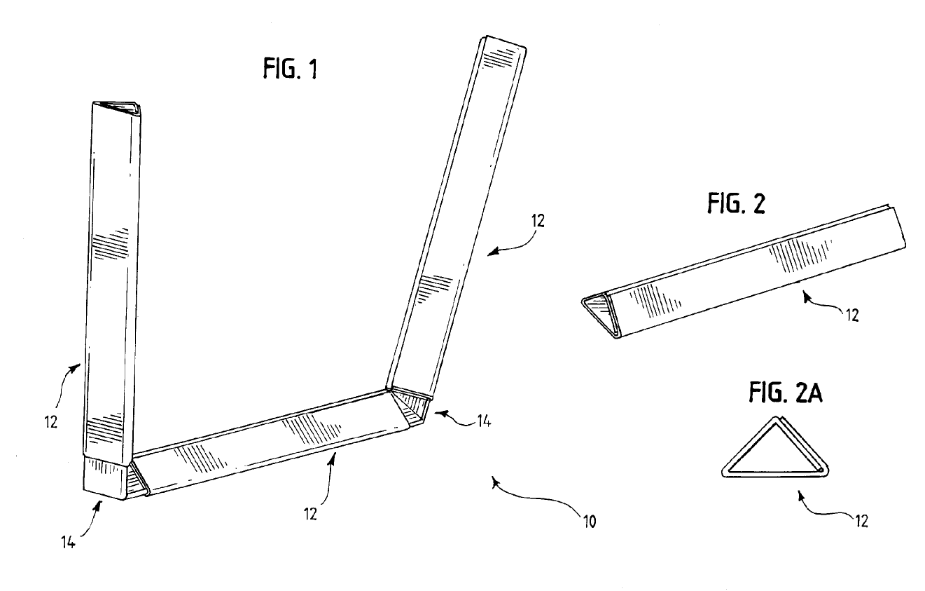

Turning to the drawings, there is shown in FIG. 1 one embodiment of the present invention, a rigid, non-round tubular shipping container 10 useful for protecting and shipping straight or non-straight items. In the preferred embodiment shown, the container 10 comprises two or more (n) rigid straight sections 12 joined by (n−1) connectors 14. However, the invention may comprise a single straight section 12 and either one or two connectors 14.

FIG. 2 is a perspective view and FIG. 2A is an end view of a straight section 12. In the illustrated embodiment, the straight section 12 comprises four substantially rectangular panels joined together along fold lines to form a rigid, hollow tubular structure with opposing ends. Each straight section 12 may be formed from a blank (not shown) that has been folded lengthwise such that one panel overlaps and is affixed to another panel by adhesive or other means as best shown in FIG. 2A. The blank may be formed from paperboard, corrugated board, plastic, metal or other suitable material. Alternatively, the straight sections 12 (and the connectors 14) may be formed by molding, extrusion (particularly if the straight section is plastic), or any other suitable means.

The straight sections 12 may have a triangular cross section as shown in the figures, or any suitable cross sectional shape, such as a rectangle or other polygon. The straight sections 12 have an internal bore that can accommodate the connectors 14 and may be cut to any length.

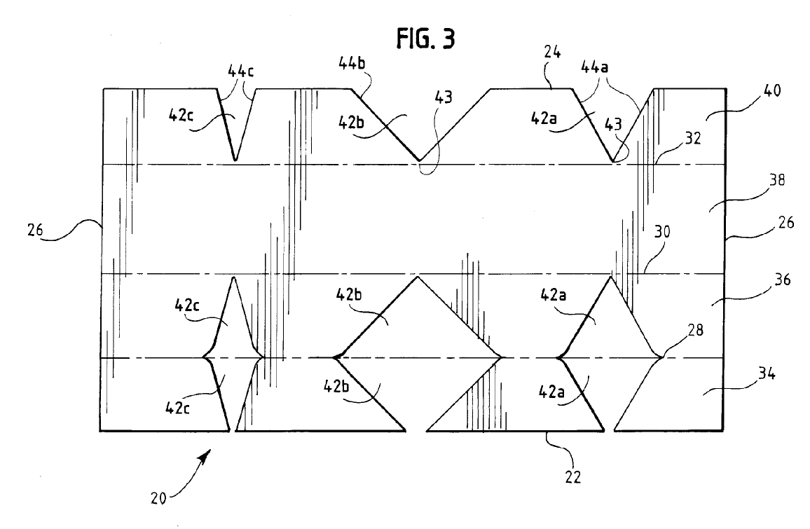

FIG. 3 is a plan view of a blank 20 used to form a connector 14. The blank 20 may be made from corrugated board, paperboard, plastic, metal or other suitable material, and comprises first and second edges 22, 24 extending between opposing ends 26. In the illustrated embodiment, parallel fold lines 28, 30, 32 extend longitudinally between the ends 26, dividing the blank into four substantially rectangular panels: a bottom panel 38, side panels 36, 40, and an overlapping panel 34.

In a key aspect of the invention, one or more V-shaped sections 42 are cut out of the side panels 36, 40 and the overlapping panel 34 such that, when the blank 20 is folded, the V-shaped cut out sections 42 align to form V-shaped notches 16 where the connector 14 can be bent, as explained more fully below.

For example, first V-shaped sections 42a may be cut out of side panels 36, 40 at an angle of 60 degrees such that their apexes 43 are adjacent the bottom panel 36. Another V-shaped section 42a is cut out of the overlapping panel 34 such that its base (the side away from the apex) adjoins the base of the V-shaped section 42a cut out of the side panel 36.

Each of the three V-shaped cut out sections 42a is defined by opposing edges 44a. When the blank 20 is assembled into a tubular connector 14 the opposing edges 44a define two planes that intersect at a 60 degree angle.

Likewise, second and third V-shaped sections 42b, 42c may be cut out of side panels 36, 40 and the overlapping panel 34 at angles of 90 and 30 degrees respectively so that, when the blank 20 is assembled into a tubular connector 14, two additional V-shaped notches 16b, 16c are formed having opposing edges 44b, 44c that intersect at 90 and 30 degrees respectively.

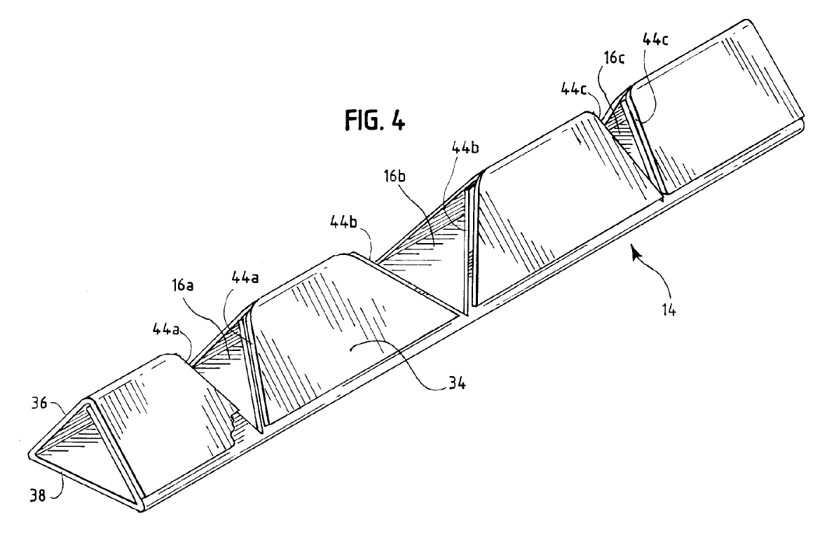

FIGS. 4-7 show various views of an assembled connector 14. To assemble the connector 14, the blank 20 is folded at the fold lines 28, 30, 32 and the overlapping panel 34 may be glued or otherwise affixed to the side panel 40.

The angle of the V-shaped notches 16 determines the angle at which the connector 14 may be folded. For example, if the angle of the notch 16 is 90 degrees (see V-shaped notch 16b), then the connector 14 may be folded at a 90 degree angle, which will cause the opposing edges 44b to abut. As shown in FIGS. 4-6, multiple notches 16a, 16b, 16c having varying angles may be die cut into a single connector 14 to provide multiple folding angles.

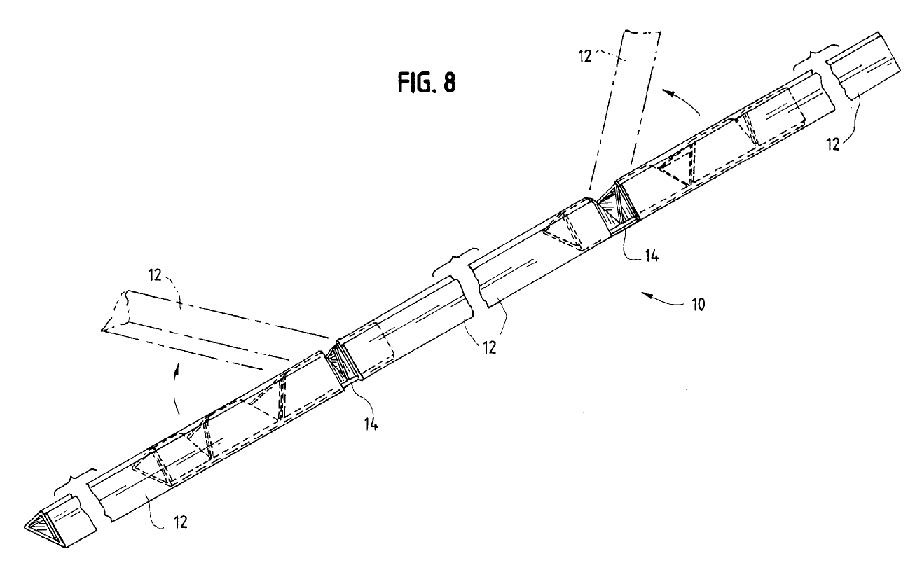

FIG. 8 is a perspective view of the multiple angle tubular container 10 of FIG. 1 before and, in phantom lines, after it has been folded or bent. To assemble the container 10 shown in FIG. 8, two connectors 14 are inserted inside either end of the center straight section 12 up to the desired V-shaped notch 16. The two connectors 14 may be slid up to V-shaped notches 16 having the same or different angles, depending on the desired bending characteristics of the container 10. Two more outer straight sections 12 are then slid over the connectors 14 up to the same V-shaped notches 16. The V-shaped notches 16 at which the container is to be bent must be completely exposed, and not covered by the outer straight sections 12, to enable the container 10 to be fully bent. The assembled container 10 can then be bent up to the predetermined angle(s) of the notches 16 using the connectors 14 as hinges.

Any number of outer straight sections 12 may be connected using the connectors 14. The connectors 14 and straight sections 12 may be glued or otherwise affixed to each other. Optional end caps (not shown) may be used to cover the exposed ends of the container 10.

The straight sections 12 and connectors 14 may be slid over the item to be protected. Alternatively, if the straight sections 12 and/or connectors 14 cannot be slid past any bends or angles in the item, the straight sections 12 and/or connectors 14 may be folded and glued around the item. In the latter instance, to remove the item the straight sections 12 and/or connectors 14 may be disassembled or destroyed.

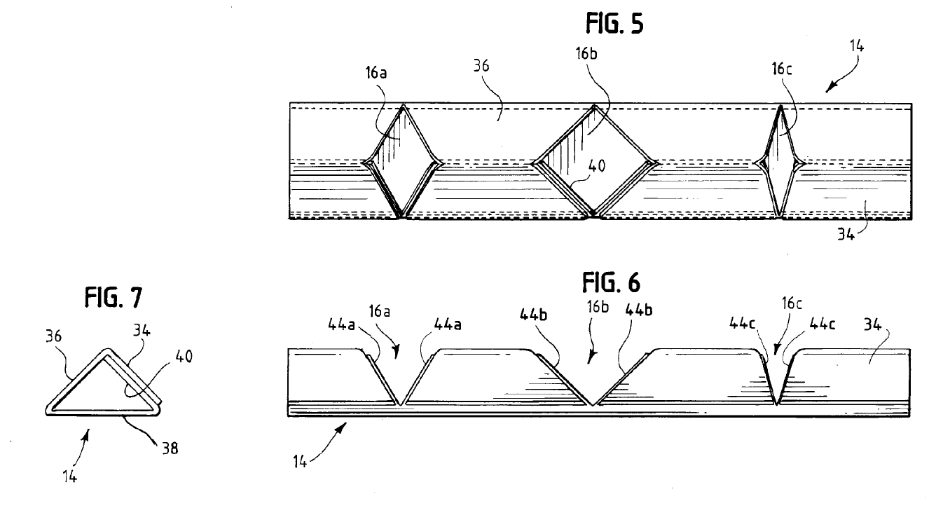

In an alternative embodiment, the container 10 comprises only a notched connector piece 14 such as that shown in FIGS. 5-7. As with the preferred embodiment, the connector piece 14 can be bent by folding it along the un-notched (bottom) panel 38 to butt the opposing edges 44 of a notch 16.

Other modifications and alternative embodiments of the invention are contemplated which do not depart from the spirit and scope of the invention as defined by the foregoing teachings and appended claims. It is intended that the claims cover all such modifications that fall within their scope.

What is claimed is:

1. A tubular container comprising:
at least one rigid, hollow straight section; and
at least one rigid, hollow tubular connector configured to fit partially within the at least one straight section, the connector comprising at least one notch at which the tubular container can bend.

2. The tubular container of claim 1 wherein the at least one notch is V-shaped.

3. The tubular container of claim 2 wherein the at least one straight section is formed from a folded blank and has a polygonal cross-section.

4. The tubular container of claim 3 wherein the straight section comprises opposing open ends and three or more substantially rectangular panels folded into a tubular shape.

5. The tubular container of claim 4 wherein the at least one tubular connector comprises three or more substantially rectangular panels folded into a tubular shape having a polygonal cross-section.

6. The tubular container of claim 5 wherein the at least one tubular connector comprises a bottom panel and two or more side panels folded into a tubular shape having a polygonal cross-section.

7. The tubular container of claim 6 wherein the at least one V-shaped notch is cut out of the side panels.

8. The tubular container of claim 7 wherein the tubular connector is formed from a blank comprising a bottom panel, side panels, and an overlapping panel divided by longitudinally extending fold lines, and one or more V-shaped sections cut out of the side panels and the overlapping panel such that, when the connector is assembled, the V-shaped sections align to form the V-shaped notches at which the connector can bend.

9. The tubular container of claim 8 wherein the at least one straight section and the at least one tubular connector have triangular cross sections.

10. A tubular container comprising at least one rigid, hollow tubular connector piece, the connector piece having a polygonal cross-section and comprising at least one notch at which the tubular container can bend.

11. The tubular container of claim 10 wherein the notch is formed from a blank comprising a bottom panel, side panels, and an overlapping panel divided by longitudinally extending fold lines and one or more V-shaped sections cut out of the side panels and the overlapping panel such that, when the connector is assembled, the V-shaped sections align to form the V-shaped notches at which the connector can bend.

12. The tubular container of claim 10 wherein the connector piece has a triangular cross-section.
